(19) United States
(12) Patent Application Publication
(10) Pub. No.: US 2026/0058054 A1
(43) Pub. Date: Feb. 26, 2026

(54) IGNITION COIL AND IGNITION DEVICE

(71) Applicant: DIAMOND&ZEBRA ELECTRIC MFG.CO.,LTD., Osaka (JP)

(72) Inventors: Takaaki MIURA, Osaka (JP); Mitsuhiro IZUMI, Osaka (JP)

(21) Appl. No.: 19/238,675

(22) Filed: Jun. 16, 2025

(30) Foreign Application Priority Data
Aug. 20, 2024 (JP) 2024-139320

(51) Int. Cl. H01F 38/12; F02P 3/04; H01F 27/24; H01F 27/28

(52) U.S. Cl. CPC H01F 38/12; F02P 3/0435; H01F 27/24; H01F 27/28

(57) ABSTRACT

An ignition coil accommodated in a casing includes first and second penetrating cores, a one-end peripheral core, and an other-end peripheral core. The first penetrating core penetrates the inside of a first primary coil and the inside of a first secondary coil. The second penetrating core penetrates the inside of a second primary coil and the inside of a second secondary coil. The one-end peripheral core connects one ends of the first and second penetrating cores. The other-end peripheral core connects the other ends of the first and second penetrating cores. The casing is opened upward to have a concave shape filled with mold resin. Respective upper ends of the one-end peripheral core and the other-end peripheral core are positioned above first and second secondary coils. This allows heat generated from the two primary coils included in the ignition coil to be efficiently dissipated to the outside of the casing.

### RELATED APPLICATIONS

This application claims the benefit of Japanese Application No. 2024-139320, filed on August 20, 2024, the disclosure of which is incorporated by reference herein.

### BACKGROUND OF THE INVENTION

### FIELD OF THE INVENTION

The present disclosure relates to an ignition coil for use in an internal combustion engine and an ignition device including the ignition coil.

### Description of the Background Art

Conventionally, in an internal combustion engine of an automobile or the like, in order to improve fuel efficiency as a countermeasure against exhaustion of resources, lean combustion is performed in which a lean fuel having a fuel ratio lower than the theoretical air-fuel ratio is burned, in some cases. Meanwhile, in order to realize a decarbonized society as a countermeasure against global warming, use of ammonia containing no carbon as a fuel is under consideration. However, those fuels are typically more flame-retardant than gasoline, and high energy is required for ignition thereof. Then, in order to effectively burn those fuels, there are various ignition methods under consideration, such as a multiple ignition method in which discharge is caused to successively occur a plurality of times in a spark plug, or a dual coil offset (DCO) ignition method in which two ignition coils connected to one spark plug are caused to alternately operate, and thus discharge is caused to continuously occur in the spark plug. For example, in Japanese Patent Application Laid-Open No. 2015-129464 and Japanese Patent Application No. 2024-079877, an ignition device for use in an internal combustion engine in which the DCO ignition method is adopted is disclosed.

According to Japanese Patent Application Laid-Open No. 2015-129464, a drive circuit (2) for generating spark discharge in a spark plug (1) includes two coil pairs (11, 12). A first coil pair (11) is formed by winding a primary coil (11a) and a secondary coil (11b) around an iron core (10). Meanwhile, a second coil pair (12) is formed by winding a primary coil (12a) and a secondary coil (12b) around the iron core (10) (see paragraph [0017] and FIGS. 1 and 2). Further, the iron core (10) is formed by bringing components each including a plurality of stacked thin iron sheets into contact with each other with no gap. Moreover, both of a magnetic flux (Φ1) generated by energization of the primary coil (11a) of the first coil pair (11) and a magnetic flux (Φ2) generated by energization of the primary coil (12a) of the second coil pair (12) pass through a common portion (11c) in the iron core (10) (see paragraph [0018]).

According to Japanese Patent Application No. 2024-079877, an ignition coil (104) connected to a spark plug (101) includes a first coil set (40), a second coil set (50), and an iron core (60) (see paragraph [0025]). The iron core (60) has a structure in which a first core (61), a second core (62), a one-end connecting core (63), and an other-end connecting core (64) are combined. The first core (61) penetrates the inside of a first primary coil (L11) and the inside of a first secondary coil (L12) of the first coil set (40). The second core (64) penetrates the inside of a second primary coil (L21) and the inside of a second secondary coil (L22) of the second coil set (50) (see paragraph [0031]). Meanwhile, the one-end connecting core (63) connects one end (611) of the first core (61) and one end (621) of the second core (62). Meanwhile, the other-end connecting core (64) connects the other end (612) of the first core (61) and the other end (622) of the second core (62) (see paragraph [0032]). Thus, there is formed one ring-shaped closed magnetic circuit in which the first core (61), the one-end connecting core (63), the second core (62), and the other-end connecting core (64) are connected in the stated order.

In this regard, according to Japanese Patent Application No. 2024-079877, as described at the paragraph [0025], the iron cores and the two coil sets connected to the spark plug, together with other components, are accommodated in a casing (not shown) in an integrated manner. Further, gaps in the casing are filled with thermosetting mold resin for fixing the respective components while insulating them from each other. For the mold resin, for example, epoxy resin is used. The epoxy resin has thermal conductivity as low as approximately 0.1 to 0.8 W/mK. Meanwhile, an electrical steel sheet (35A300) forming the iron cores has thermal conductivity of approximately 20 W/mK.

Further, at the time of driving the ignition coil, a current flows through each primary coil every time the primary coil of each coil set surrounded by the mold resin in the casing is charged up. Hence, as a result of repeating charging of each primary coil, heat generated from each primary coil remains in the casing, possibly leading to erosion or malfunction of peripheral components. In view of this, the structure of the ignition coil is susceptible to contrivance in order to allow heat generated from each primary coil to be efficiently dissipated to the outside of the casing.

### SUMMARY OF THE INVENTION

It is an object of the present disclosure to provide a technology that applies contrivance to a structure of an ignition coil in which two coil sets connected to a spark plug are accommodated in a casing, to thereby allow heat generated from each primary coil to be efficiently dissipated to the outside of the casing.

In order to solve the above-described problem, the first invention of the present application is directed to an ignition coil for use in an internal combustion engine, including a first primary coil, a first secondary coil, a first penetrating core, a second primary coil, second secondary coil, a second penetrating core, a one-end peripheral core, an other-end peripheral core, and a casing. The first primary coil includes a first primary winding, in which a direct-current voltage is applied to one end and the other end is connected to a ground point. The first secondary coil includes a first secondary winding. The first penetrating core penetrates an inside of the first primary coil and an inside of the first secondary coil and is configured to electromagnetically couple the first primary coil and the first secondary coil. The second primary coil includes a second primary winding, in which the direct-current voltage is applied to one end and the other end is connected to the ground point. The second secondary coil includes a second secondary winding. The second penetrating core penetrates an inside of the second primary coil and an inside of the second secondary coil and is configured to electromagnetically couple the second primary coil and the second secondary coil. The one-end peripheral core connects one end of the first penetrating core and one end of the second penetrating core. The other-end peripheral core connects the other end of the first penetrating core and the other end of the second penetrating core. The casing is opened upward to have a concave shape in which an opening is formed at an upper end, and accommodates the first primary coil, the first secondary coil, the first penetrating core, the second primary coil, the second secondary coil, the second penetrating core, the one-end peripheral core, and the other-end peripheral core. The casing is filled with thermosetting mold resin. Respective upper ends of the one-end peripheral core and the other-end peripheral core are positioned above the first secondary coil and the second secondary coil.

The second invention of the present application is directed to the ignition coil according to the first invention, wherein the upper end of the one-end peripheral core and/or the upper end of the other-end peripheral core are exposed above an upper surface of the mold resin.

The third invention of the present application is directed to the ignition coil according to the first invention or the second invention, further including a central core that is placed between the first penetrating core and the second penetrating core and connects the one-end peripheral core and the other-end peripheral core.

The fourth invention of the present application is directed to the ignition coil according to the third invention, wherein the central core and at least a part of the one-end peripheral core and/or at least a part of the other-end peripheral core are formed of one same component.

The fifth invention of the present application is directed to the ignition coil according to the third invention, wherein the central core and at least a part of the one-end peripheral core and/or at least a part of the other-end peripheral core are formed of different components, respectively.

The sixth invention of the present application is directed to an ignition device including the ignition coil according to any one of the first to fifth inventions, a power supply device, a first switching element, a second switching element, a first control unit, a second control unit, and a spark plug. The power supply device is configured to apply the direct-current voltage to each of the one end of the first primary coil and the one end of the second primary coil. The first switching element is interposed between the other end of the first primary coil and the ground point and is configured to perform switching between passage and interruption of a first primary current flowing from the power supply device to the first primary coil. The second switching element is interposed between the other end of the second primary coil and the ground point and is configured to perform switching between passage and interruption of a second primary current flowing from the power supply device to the second primary coil. The first control unit is configured to control the switching of the first switching element. The second control unit is configured to control the switching of the second switching element. The spark plug is configured to ignite a fuel by occurrence of discharge at a gap in accordance with a high voltage induced at one end of the first secondary coil and/or a high voltage induced at one end of the second secondary coil.

The seventh invention of the present application is directed to the ignition device according to the sixth invention, further including a high-voltage terminal that is held below the ignition coil in the casing and is interposed in a conductor connecting the one end of the first secondary coil and the one end of the second secondary coil to the spark plug.

According to the first to seventh inventions of the present application, the respective upper ends of the one-end peripheral core and the other-end peripheral core are placed at upper positions near the opening of the casing, and thus it is possible to transfer heat generated from each coil, to the upper side, while suppressing the influence of thermal resistance of the mold resin. This allows heat generated from each coil to be dissipated to above the casing via the one-end peripheral core and/or the other-end peripheral core.

Especially, according to the second invention of the present application, heat can be more efficiently dissipated to above the casing via the one-end peripheral core and/or the other-end peripheral core.

Especially, according to the fourth invention of the present application, the number of components in the entire ignition coil including the iron core can be reduced.

Especially, according to the fifth invention of the present application, the central core and the one-end peripheral core and/or the other-end peripheral core can be easily formed with the use of high-yield steel sheet materials.

### BRIEF DESCRIPTION OF THE DRAWINGS

FIG. 1 is a block diagram schematically showing an operating environment of an ignition device for use in an internal combustion engine according to a first preferred embodiment;

FIG. 2 is a perspective view of the ignition device according to the first preferred embodiment;

FIG. 3 is a perspective view of the ignition device according to the first preferred embodiment;

FIG. 4 is a perspective view of the ignition device according to the first preferred embodiment;

FIG. 5 is a perspective view of an ignition coil according to the first preferred embodiment;

FIG. 6 is a schematic longitudinal sectional view of the ignition coil according to the first preferred embodiment, as seen from below;

FIG. 7 is a perspective view of an ignition device according to a first modification;

FIG. 8 is a perspective view of an ignition coil according to a second modification;

FIG. 9 is a perspective view of an ignition coil according to a second preferred embodiment;

FIG. 10 is a perspective view of an ignition coil according to a third modification; FIG. 11 is a perspective view of the ignition coil according to the third modification, from which a resin cover is removed; and

FIG. 12 is a perspective view of an ignition coil according to a fourth modification, from which a resin cover is removed.

### DESCRIPTION OF THE PREFERRED EMBODIMENTS

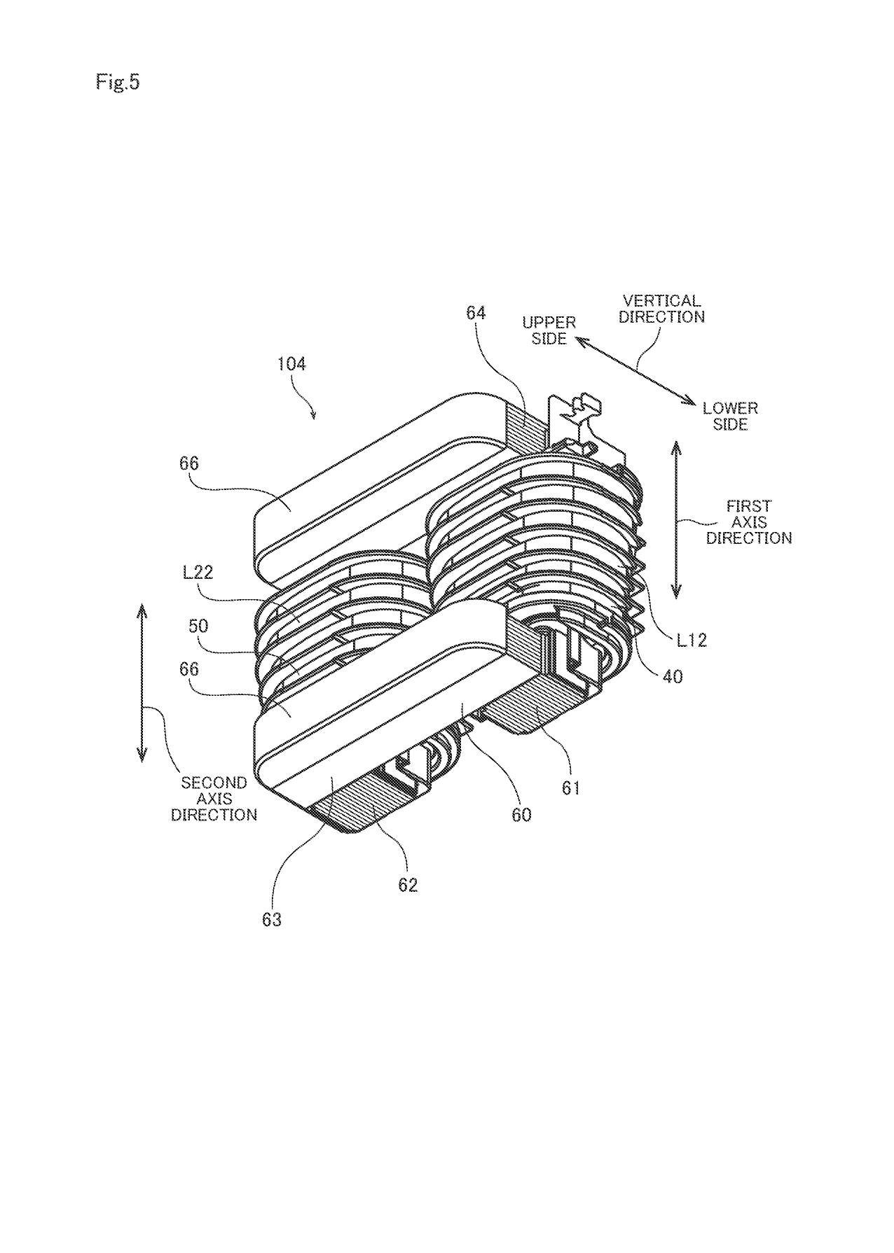

Hereinafter, illustrative preferred embodiments of the present disclosure will be described with reference to the drawings. Note that components described in these preferred embodiments are mere examples, and are not intended to limit the scope of the present invention to those only. Further, in the drawings, for the purpose of easier understanding, the dimensions and the number of respective components are overstated or understated in some portions of illustration, as necessary. Moreover, in FIG. 5 and FIGS. 8 to 12 described later, silicon steel sheets stacked in laminated steel are shown in a simplified manner in some portions of illustration.

### <1. First Preferred Embodiment>

### <1-1. Configuration of Ignition Device>

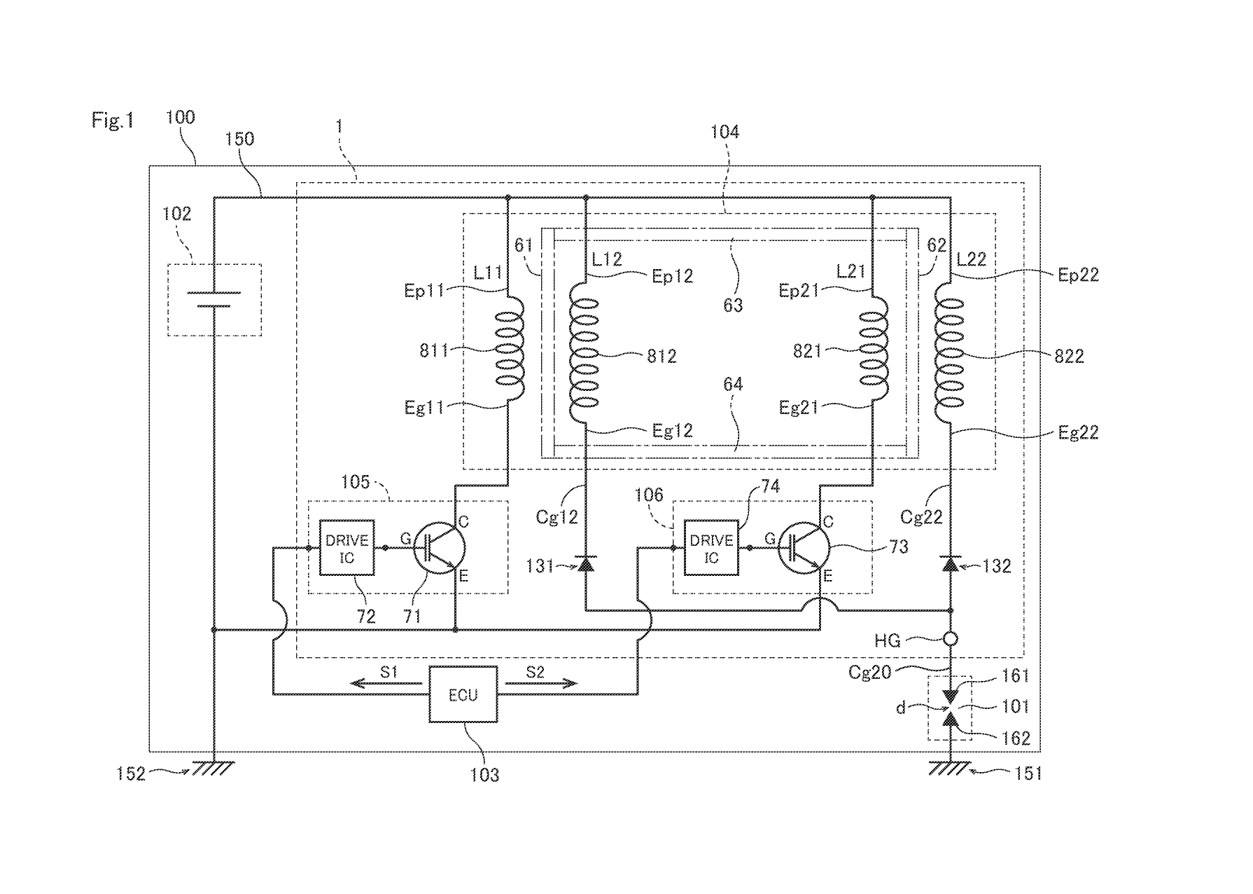

First, a configuration of an ignition device 1 for use in an internal combustion engine corresponding to a first preferred embodiment of the present disclosure will be described with reference to the drawings. FIG. 1 is a block diagram schematically showing an operating environment of the ignition device 1 according to the first preferred embodiment. Note that a first primary coil L11 and a first secondary coil L12 of an ignition coil 104 included in the ignition device 1 are arranged in a direction in which the coils are stacked on each other as described later, but they are shown as being arranged adjacently to each other in FIG. 1 for the purpose of easy understanding. Likewise, a second primary coil L21 and a second secondary coil L22 of the ignition coil 104 are arranged in a direction in which the coils are stacked on each other, but they are shown as being arranged adjacently to each other in FIG. 1 for the purpose of easy understanding.

The ignition device 1 according to the present embodiment is, for example, a device that is mounted in an internal combustion engine such as a spark-ignition (SI) reciprocating engine mounted in a vehicle body 100 of an automobile or the like and applies a high voltage for causing spark discharge to occur in a spark plug 101. The ignition device 1 is provided in one cylinder or each of a plurality of cylinders included in the internal combustion engine.

Further, as shown in FIG. 1, the internal combustion engine includes the spark plug 101, in addition to the ignition device 1, and the vehicle body 100 includes a power supply device 102 (battery) and an engine control unit (ECU) 103. Note that, in a broad sense, the spark plug 101, the power supply device 102, and the ECU 103 can be regarded as being included in the ignition device 1.

The spark plug 101 is a device for performing an ignition operation in a combustion chamber of the internal combustion engine. The spark plug 101 is electrically connected to one end Eg12 of the first secondary coil L12 of the ignition coil 104 described later via a conductor. Hereinafter, the conductor connecting the spark plug 101 and the one end Eg12 of the first secondary coil L12 will be referred to as a “first secondary-side ground wire Cg12”. The spark plug 101 is interposed between the one end Eg12 of the first secondary coil L12 and a ground point (ground) 151. Further, the spark plug 101 is electrically connected to one end Eg22 of a second secondary coil L22 of the ignition coil 104 described later via a conductor. Hereinafter, the conductor connecting the spark plug 101 and the one end Eg22 of the second secondary coil L22 will be referred to as a “second secondary-side ground wire Cg22”. The spark plug 101 is interposed between the one end Eg22 of the second secondary coil L22 and the ground point 151. That is, in the ignition device 1, one spark plug 101 is provided in common between a first coil set 40 and a second coil set 50 that will be described later.

A high voltage is induced in the first secondary coil L12 and/or the second secondary coil L22 of the ignition coil 104. Then, when a sum of a high voltage induced at the one end Eg12 of the first secondary coil L12 and a high voltage induced at the one end Eg22 of the second secondary coil L22 exceeds an electrical breakdown voltage at a gap d (refer to FIG. 1) between a center electrode 161 and a ground electrode 162 of the spark plug 101, discharge occurs at the gap d, so that spark is generated. As a result, a fuel supplied to the internal combustion engine is ignited. In other words, the spark plug 101 ignites a fuel by occurrence of discharge at the gap d, in accordance with a high voltage induced at the one end Eg12 of the first secondary coil L12 and/or a high voltage induced at the one end Eg22 of the second secondary coil L22.

Meanwhile, the first secondary-side ground wire Cg12 and the second secondary-side ground wire Cg22 join together on the way to the spark plug 101, to become a “secondary-side ground wire Cg20”. The spark plug 101 is interposed in the secondary-side ground wire Cg20. Further, in front of the spark plug 101 (on a side opposite to the ground point 151), a high-voltage terminal HG is provided. Specifically, the high-voltage terminal HG is interposed in the secondary-side ground wire Cg20 that is a conductor connecting the one end Eg12 of the first secondary coil L12 and the one end Eg22 of the second secondary coil L22 to the spark plug 101. A high-voltage output of the first secondary coil L12 and a high-voltage output of the second secondary coil L22 are transferred to the spark plug 101 via the high-voltage terminal HG.

The power supply device 102 is a direct-current power chargeable/dischargeable storage battery. In the present embodiment, the power supply device 102 is electrically connected to each of the first primary coil L11, the first secondary coil L12, the second primary coil L21, and the second secondary coil L22 of the ignition coil 104 described later, via a conductor. Hereinafter, the conductor connecting the power supply device 102 and each of the first primary coil L11, the first secondary coil L12, the second primary coil L21, and the second secondary coil L22 of the ignition coil 104 described later will be referred to as a “power supply line 150”. The power supply device 102 applies a direct-current voltage to each of one end Ep11 of the first primary coil L11, the other end Ep12 of the first secondary coil L12, one end Ep21 of the second primary coil L21, and the other end Ep22 of the second secondary coil L22 of the ignition coil 104 via the power supply line 150. Meanwhile, by provision of a first diode 131 and a second diode 132 as described later, a current is prevented from flowing from the vicinity of the power supply device 102 toward the first secondary coil L12 and the second secondary coil L22.

The ECU 103 is an existing computer that comprehensively controls operations and the like of a transmission and an engine in the vehicle body 100.

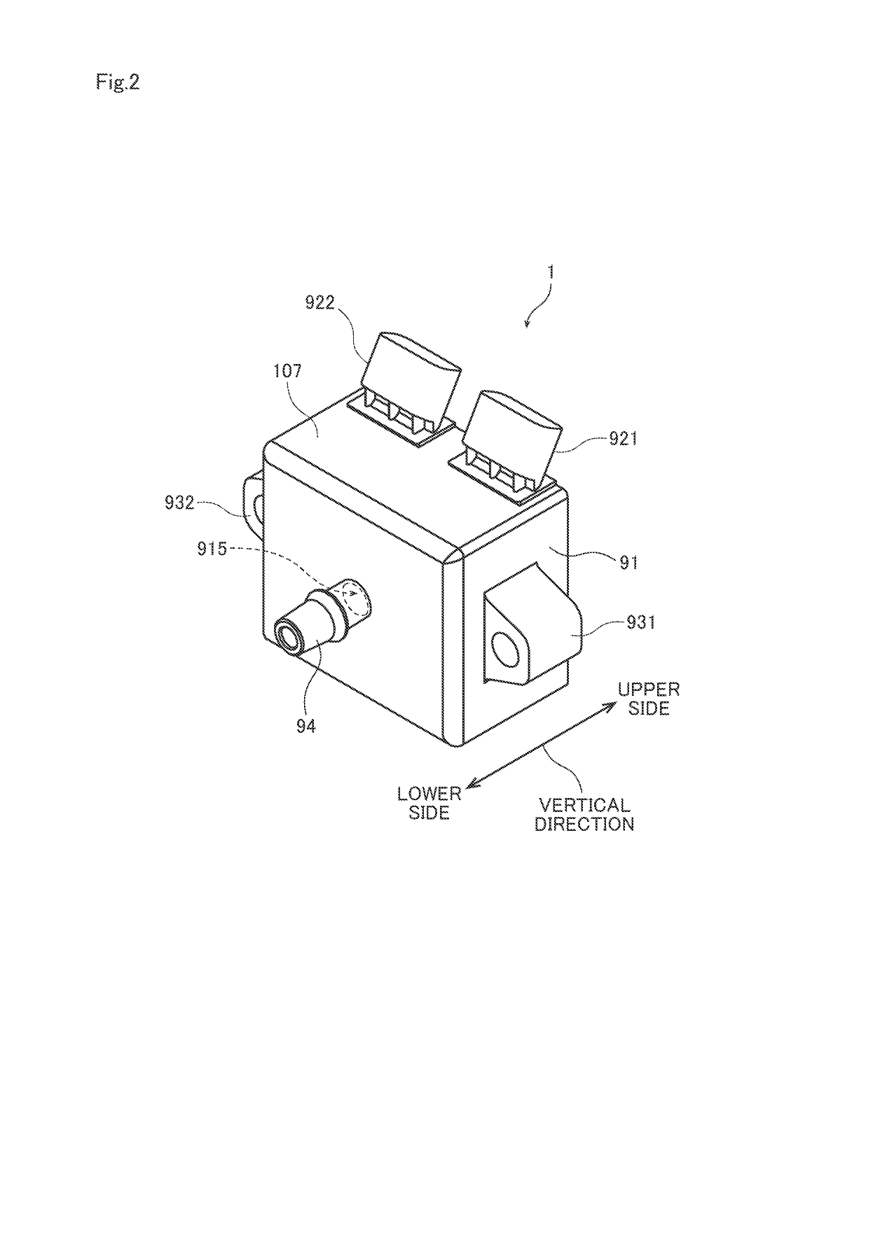

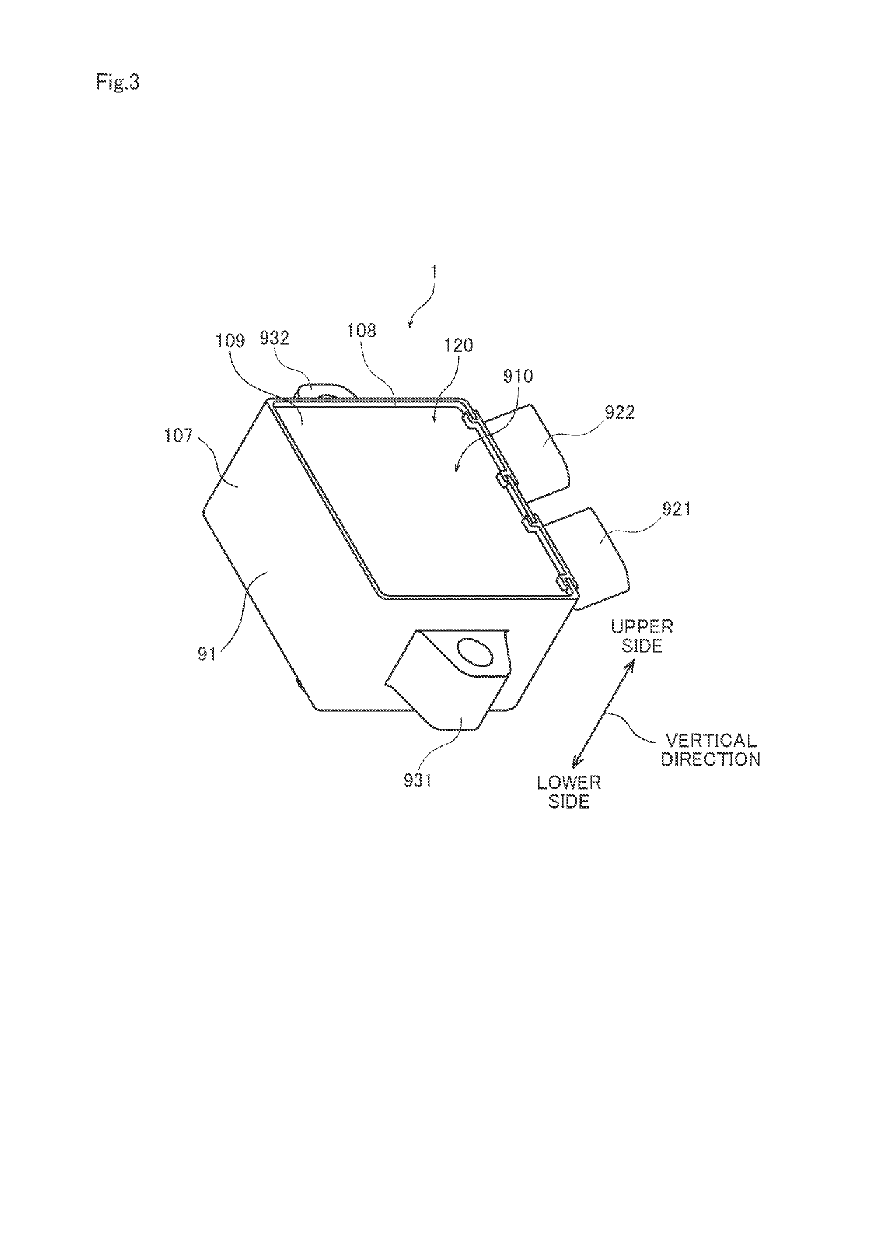

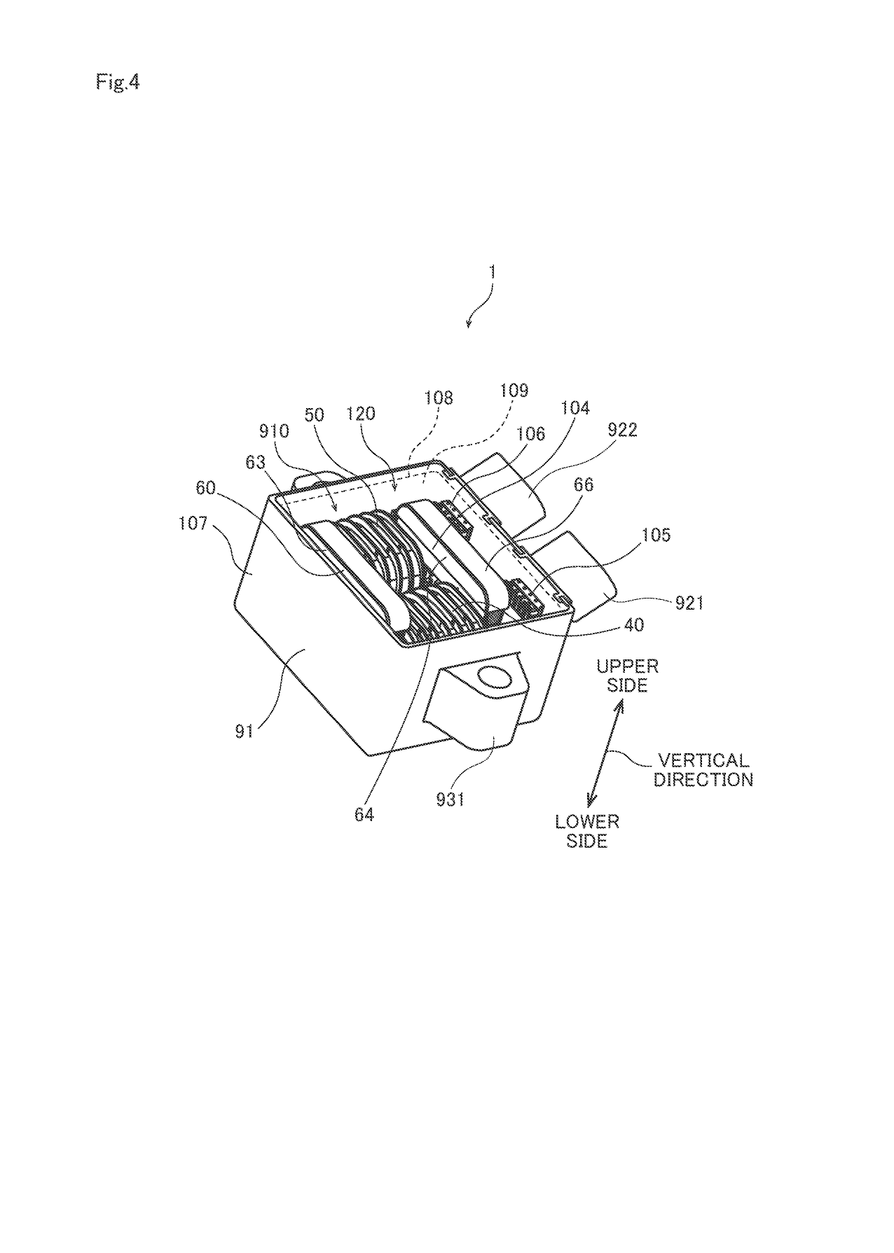

FIG. 2 is a perspective view of the ignition device 1 according to the present embodiment. FIG. 3 is a perspective view of the ignition device 1 according to the present embodiment as seen from a direction different from that in FIG. 2. FIG. 4 is a perspective view of the ignition device 1 in FIG. 3, in which a resin portion 108 described later is omitted. However, in FIG. 4, a resin surface 109 that is an upper surface of the resin portion 108 is shown by a broken line. Note that a “vertical direction”, a “vertically upper side”, and a “vertically lower side” are defined in FIG. 2 and FIGS. 5 and 7 to 10 described later for the purpose of easy understanding, but a direction in which the ignition device 1 is placed during manufacture and use of the ignition device 1 is not limited to that in those figures.

As shown in FIGS. 1 to 4, the ignition device 1 includes the ignition coil 104, a first igniter 105, a second igniter 106, a casing 107, a resin portion 108, the first diode 131, and the second diode 132. Note that, in a broad sense, the casing 107 and the resin portion 108 can be regarded as being included in the ignition coil 104.

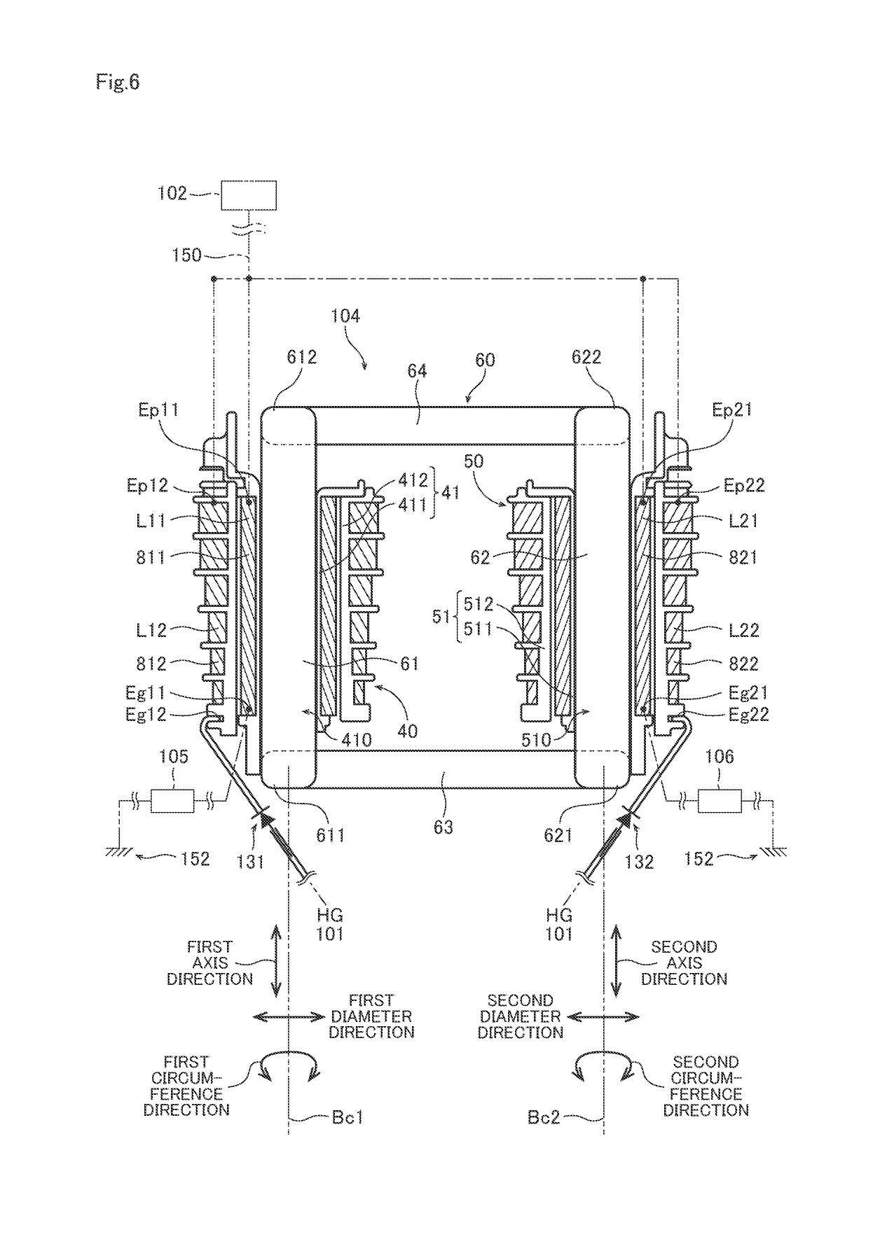

FIG. 5 is a perspective view of the ignition coil 104 according to the present embodiment. FIG. 6 is a schematic longitudinal sectional view of the ignition coil 104 as seen from below. Note that, in FIG. 6, the respective components connected to the ignition coil 104, such as the power supply device 102, are shown by a long-dashed double-dotted line. As shown in FIG. 1 and FIGS. 4 to 6, the ignition coil 104 includes the first coil set 40, the second coil set 50, and an iron core 60. The first coil set 40 and the second coil set 50 are horizontally arranged side by side. Further, as described later, the first coil set 40 and the second coil set 50 are connected in parallel to one spark plug 101. The first coil set 40 includes a first bobbin 41, the first primary coil L11, and the first secondary coil L12. The second coil set 50 includes a second bobbin 51, the second primary coil L21, and the second secondary coil L22. The ignition coil 104, together with the first igniter 105 and the second igniter 106, is incorporated in the casing 107 in an integrated manner, details of which will be given later.

Note that, in the following description about the ignition coil 104, a direction parallel with a first center axis Bc1 of the first bobbin 41, a direction perpendicular to the first center axis Bc1, and a direction along an arc having its center on the first center axis Bc1 will be referred to as a “first axis direction”, a “first diameter direction”, and a “first circumference direction”, respectively. Further, a direction parallel with a second center axis Bc2 of the second bobbin 51, a direction perpendicular to the second center axis Bc2, and a direction along an arc having its center on the second center axis Bc2 will be referred to as a “second axis direction”, a “second diameter direction”, and a “second circumference direction”, respectively. Meanwhile, the “direction parallel with something” includes a direction substantially parallel with something, and the “direction perpendicular to something” includes a direction substantially perpendicular to something. Moreover, the first center axis Bc1 and the second center axis Bc2 of the present embodiment are substantially parallel with each other, and each of the axes are substantially horizontal.

The first bobbin 41 includes a first primary bobbin 411 and a first secondary bobbin 412 that can be connected to each other. Each of the first primary bobbin 411 and the first secondary bobbin 412 extends in a tubular shape along the first center axis Bc1. Further, the first secondary bobbin 412 is placed on the outer side of the first primary bobbin 411 with respect to the first diameter direction. For a material of the first primary bobbin 411 and the first secondary bobbin 412, resin is used, for example. The first primary coil L11 is formed by winding a conductor around an outer surface of the first primary bobbin 411 in the first circumference direction having its center on the first center axis Bc1. Hereinafter, the conductor wound around the outer surface of the first primary bobbin 411 will be referred to as a “first primary winding 811”. That is, the first primary coil L11 includes the first primary winding 811.

After the first primary coil L11 is formed, the first secondary bobbin 412 is placed so as to cover the outer surface of the first primary coil L11, and is connected to the first primary bobbin 411. Then, a conductor different from the first primary winding 811 is wound around the outer surface of the first secondary bobbin 412 in the first circumference direction having its center on the first center axis Bc1, to thereby form the first secondary coil L12. Hereinafter, the different conductor wound around the outer surface of the first secondary bobbin 412 will be referred to as a “first secondary winding 812”. That is, the first secondary coil L12 includes the first secondary winding 812. Thus, by arranging the first primary coil L11 and the first secondary coil L12 such that the coils are stacked on each other, it is possible to further miniaturize the entire ignition coil 104 including those coils. However, the arrangement of the first primary coil L11 and the first secondary coil L12 is not limited to the above-described case in which the coils are stacked on each other. Alternatively, for example, the first primary coil L11 and the first secondary coil L12 may be arranged adjacently to each other along the first axis direction.

The second bobbin 51 includes a second primary bobbin 511 and a second secondary bobbin 512 that can be connected to each other. Each of the second primary bobbin 511 and the second secondary bobbin 512 extends in a tubular shape along the second center axis Bc2. Further, the second secondary bobbin 512 is placed on the outer side of the second primary bobbin 511 with respect to the second diameter direction. For a material of the second primary bobbin 511 and the second secondary bobbin 512, resin is used, for example. The second primary coil L21 is formed by winding a conductor around an outer surface of the second primary bobbin 511 in the second circumference direction having its center on the second center axis Bc2. Hereinafter, the conductor wound around the outer surface of the second primary bobbin 511 will be referred to as a “second primary winding 821”. That is, the second primary coil L21 includes the second primary winding 821.

After the second primary coil L21 is formed, the second secondary bobbin 512 is placed so as to cover the outer surface of the second primary coil L21, and is connected to the second primary bobbin 511. Then, a conductor different from the second primary winding 821 is wound around the outer surface of the second secondary bobbin 512 in the second circumference direction having its center on the second center axis Bc2, to thereby form the second secondary coil L22. Hereinafter, the different conductor wound around the outer surface of the second secondary bobbin 512 will be referred to as a “second secondary winding 822”. That is, the second secondary coil L22 includes the second secondary winding 822. Thus, by arranging the second primary coil L21 and the second secondary coil L22 such that the coils are stacked on each other, it is possible to further miniaturize the entire ignition coil 104 including those coils. However, the arrangement of the second primary coil L21 and the second secondary coil L22 is not limited to the above-described case in which the coils are stacked on each other. Alternatively, for example, the second primary coil L21 and the second secondary coil L22 may be arranged adjacently to each other along the second axis direction.

The iron core 60 of the present embodiment has a structure in which a first penetrating core 61, a second penetrating core 62, a one-end peripheral core 63, and an other-end peripheral core 64 are combined. Each of the first penetrating core 61, the second penetrating core 62, the one-end peripheral core 63, and the other-end peripheral core 64 is formed of, for example, laminated steel in which silicon steel sheets are stacked. Note that it is generally known that a silicon steel sheet is an electrical steel sheet formed by heat treatment and rolling of steel containing iron mixed with a few percent of silicon. Alternatively, for each of the first penetrating core 61, the second penetrating core 62, the one-end peripheral core 63, and the other-end peripheral core 64, another kind of steel sheet different from a silicon steel sheet may be used. Further alternatively, for each of the first penetrating core 61, the second penetrating core 62, the one-end peripheral core 63, and the other-end peripheral core 64, a dust core formed of a sintered material may be used.

The first penetrating core 61 extends substantially horizontally and in a column shape along the first center axis Bc1. Further, the first penetrating core 61 is inserted through a space 410 on an inner side with respect to the first diameter direction in the first primary bobbin 411. In other words, the first penetrating core 61 penetrates the inside of the first primary coil L11 and the inside of the first secondary coil L12. The second penetrating core 62 extends substantially horizontally and in a column shape along the second center axis Bc2. Further, the second penetrating core 62 is inserted through a space 510 on an inner side with respect to the second diameter direction in the second primary bobbin 511. In other words, the second penetrating core 62 penetrates the inside of the second primary coil L21 and the inside of the second secondary coil L22.

Each of the one-end peripheral core 63 and the other-end peripheral core 64 of the present embodiment extends substantially horizontally and in a column shape along a direction substantially perpendicular to the first center axis Bc1 and the second center axis Bc2. More specifically, as shown in FIGS. 5 and 6, the one-end peripheral core 63 is placed above one end 611 of the first penetrating core 61 and above one end 621 of the second penetrating core 62. Thus, the one-end peripheral core 63 connects the one end 611 of the first penetrating core 61 and the one end 621 of the second penetrating core 62. Meanwhile, the other-end peripheral core 64 is placed above the other end 612 of the first penetrating core 61 and above the other end 622 of the second penetrating core 62. Thus, the other-end peripheral core 64 connects the other end 612 of the first penetrating core 61 and the other end 622 of the second penetrating core 62.

As a result, there is formed one ring-shaped closed magnetic circuit in which the first penetrating core 61, the one-end peripheral core 63, the second penetrating core 62, and the other-end peripheral core 64 are connected in the stated order. Further, the first penetrating core 61 electromagnetically couples the first primary coil L11 and the first secondary coil L12. Meanwhile, the second penetrating core 62 electromagnetically couples the second primary coil L21 and the second secondary coil L22.

Note that it is preferred that silicon steel sheets are stacked in a direction perpendicular to a direction in which a magnetic flux travels in the closed magnetic circuit in each of the first penetrating core 61, the second penetrating core 62, the one-end peripheral core 63, and the other-end peripheral core 64. Alternatively, silicon steel sheets may be stacked in a direction different from the direction perpendicular to the direction in which a magnetic flux travels in the closed magnetic circuit in each of the first penetrating core 61, the second penetrating core 62, the one-end peripheral core 63, and the other-end peripheral core 64.

Moreover, because of space limitations caused by placement of the ignition coil 104 in the casing 107, each of the first penetrating core 61 and the second penetrating core 62 extends substantially horizontally and in a column shape while the ignition coil 104 is accommodated in the casing 107. Hence, the first penetrating core 61 is present at a position farther from an opening 120 of the casing 107 described later than an upper end of the first primary coil L11 while being accommodated in the casing 107. Likewise, the second penetrating core 62 is present at a position farther from the opening 120 of the casing 107 than an upper end of the second primary coil L21 while being accommodated in the casing 107. Each of the first penetrating core 61 and the second penetrating core 62 is placed away also from a side surface of the casing 107. Meanwhile, respective upper ends of the one-end peripheral core 63 and the other-end peripheral core 64 are positioned above the first secondary coil L12 and the second secondary coil L22. Effects produced by the above-described configuration will be later described in detail.

As described above, the one end Ep11 of the first primary coil L11 is connected to the power supply line 150 that is a conductor extending from the power supply device 102. The other end Eg11 of the first primary coil L11 is connected to a ground point (ground) 152 via the first igniter 105 described later. Under control of the first igniter 105, a low direct-current voltage from the power supply device 102 is applied to the one end Ep11 of the first primary coil L11, and a first primary current that gradually increases starts flowing through the first primary coil L11. In the present embodiment, when a direct-current voltage from the power supply device 102 is applied to the first primary coil L11, an energization magnetic flux directed from the other end 612 to the one end 611 is generated in the first penetrating core 61.

The first secondary winding 812 has a wire diameter smaller than a wire diameter of the first primary winding 811. Further, the number of turns of the first secondary winding 812 in the first secondary coil L12 is larger than the number of turns of the first primary winding 811 in the first primary coil L11. For example, the number of turns of the first secondary winding 812 in the first secondary coil L12 is about 100 times or more the number of turns of the first primary winding 811 in the first primary coil L11. Thus, the ignition coil 104 steps up low direct-current voltage power supplied from the power supply device 102 to, for example, several thousands of volts to several tens of thousands of volts during interruption of the first primary current. That is, a high voltage is induced in the first secondary coil L12. Then, the first secondary coil L12 supplies the induced high-voltage power to the spark plug 101 via the secondary-side ground wires Cg12 and Cg20. In this manner, electric spark is generated in the spark plug 101, and a fuel is ignited.

Note that, as shown in FIG. 1, in the first secondary-side ground wire Cg12, the first diode 131 is connected in series to the first secondary coil L12. The first diode 131 is forward-biased from the one end Eg12 to the other end Ep12 of the first secondary coil L12. Thus, an induced current caused by a voltage that is induced in the first secondary coil L12 by the first primary current gradually increasing during energization of the first primary coil L11 is prevented from flowing to the spark plug 101 in a reverse direction. Further, as described above, the other end Ep12 of the first secondary coil L12 is connected to the power supply line 150 that is a conductor extending from the power supply device 102.

Meanwhile, as described above, the one end Ep21 of the second primary coil L21 is connected to the power supply line 150 that is a conductor extending from the power supply device 102. The other end Eg21 of the second primary coil L21 is connected to the ground point 152 via the second igniter 106 described later. Under control of the second igniter 106, a low direct-current voltage from the power supply device 102 is applied to the one end Ep21 of the second primary coil L21, and a second primary current that gradually increases starts flowing through the second primary coil L21. In the present embodiment, when a direct-current voltage from the power supply device 102 is applied to the second primary coil L21, an energization magnetic flux directed from the other end 622 to the one end 621 is generated in the second penetrating core 62.

The second secondary winding 822 has a wire diameter smaller than a wire diameter of the second primary winding 821. Further, the number of turns of the second secondary winding 822 in the second secondary coil L22 is larger than the number of turns of the second primary winding 821 in the second primary coil L21. For example, the number of turns of the second secondary winding 822 in the second secondary coil L22 is about 100 times or more the number of turns of the second primary winding 821 in the second primary coil L21. Thus, the ignition coil 104 steps up low direct-current voltage power supplied from the power supply device 102 to, for example, several thousands of volts to several tens of thousands of volts during interruption of the second primary current. That is, a high voltage is induced in the second secondary coil L22. Then, the second secondary coil L22 supplies the induced high-voltage power to the spark plug 101 via the secondary-side ground wires Cg22 and Cg20. Consequently, electric spark generated in the spark plug 101 can be maintained for a longer period of time.

Note that, as shown in FIG. 1, in the second secondary-side ground wire Cg22, the second diode 132 is connected in series to the second secondary coil L22. The second diode 132 is forward-biased from the one end Eg22 to the other end Ep22 of the second secondary coil L22. Thus, an induced current caused by a voltage that is induced in the second secondary coil L22 by the second primary current gradually increasing during energization of the second primary coil L21 is prevented from flowing to the spark plug 101 in a reverse direction. Further, as described above, the other end Ep22 of the second secondary coil L22 is connected to the power supply line 150 that is a conductor extending from the power supply device 102.

As described above, in the present embodiment, in the ignition coil 104, the first penetrating core 61 inserted through the first coil set 40 and the second penetrating core 62 inserted through the second coil set 50 are connected to each other via the one-end peripheral core 63 and the other-end peripheral core 64, thereby to form one closed magnetic circuit. This enables miniaturization of the entire ignition coil 104 including the iron core 60 as compared to a case in which a closed magnetic circuit is formed for each of the coil sets 40 and 50. Consequently, the ignition device 1 including the ignition coil 104 can be more easily mounted in the internal combustion engine. Further, the number of components can be reduced, resulting in reduction of a manufacturing cost for the entire device.

The first igniter 105 is a semiconductor device that is connected to the first primary coil L11 and controls a current flowing through the first primary coil L11. Further, the first igniter 105 is electrically connected to the ECU 103 and receives a signal from the ECU 103. Hereinafter, the signal received by the first igniter 105 from the ECU 103 will be referred to as a “first EST signal S1”. The first igniter 105 includes a first switching element 71 and a first drive IC 72. Note that the first igniter 105 may be integral with an electronic circuit of the ECU 103.

For the first switching element 71, for example, an insulated gate bipolar transistor (IGBT) is used. The first switching element 71 is interposed between the other end Eg11 of the first primary coil L11 and the ground point 152. A collector (C) of the first switching element 71 is connected to the other end Eg11 of the first primary coil L11. An emitter (E) of the first switching element 71 is connected to the ground point 152. A gate (G) of the first switching element 71 is connected to the first drive IC 72.

This configuration allows the first switching element 71 to perform switching between passage and interruption of the first primary current flowing from the power supply device 102 to the first primary coil L11. When the first switching element 71 is placed in a closed state, the first primary current flows from the power supply device 102 to the first primary coil L11. When the first switching element 71 is placed in an open state, the first primary current flowing through the first primary coil L11 is interrupted. Note that another kind of transistor may be used for the first switching element 71.

The first drive IC 72 controls switching of the first switching element 71 in response to the first EST signal S1 received from the ECU 103. The first drive IC 72 is one example of a “first control unit” of the present disclosure. The first drive IC 72 includes a logic device connected to the first switching element 71. The logic device includes, for example, a logic circuit, a processor, a complex programmable logic device (CPLD), a field-programmable gate array (FPGA), an application-specific integrated circuit (ASIC), or the like. The logic device performs arithmetic processing for causing the ignition device 1 to operate, to achieve ignition in the spark plug 101.

The second igniter 106 is a semiconductor device that is connected to the second primary coil L21 and controls a current flowing through the second primary coil L21. Further, the second igniter 106 is electrically connected to the ECU 103 and receives a signal from the ECU 103. Hereinafter, the signal received by the second igniter 106 from the ECU 103 will be referred to as a “second EST signal S2”. The second igniter 106 includes a second switching element 73 and a second drive IC 74. Note that the second igniter 106 may be integral with the electronic circuit of the ECU 103.

For the second switching element 73, for example, an insulated gate bipolar transistor (IGBT) is used. The second switching element 73 is interposed between the other end Eg21 of the second primary coil L21 and the ground point 152. A collector (C) of the second switching element 73 is connected to the other end Eg21 of the second primary coil L21. An emitter (E) of the second switching element 73 is connected to the ground point (ground) 152. A gate (G) of the second switching element 73 is connected to the second drive IC 74.

This configuration allows the second switching element 73 to perform switching between passage and interruption of the second primary current flowing from the power supply device 102 to the second primary coil L21. When the second switching element 73 is placed in a closed state, the second primary current flows from the power supply device 102 to the second primary coil L21. When the second switching element 73 is placed in an open state, the second primary current flowing through the second primary coil L21 is interrupted. Note that another kind of transistor may be used for the second switching element 73.

The second drive IC 74 controls switching of the second switching element 73 in response to the second EST signal S2 received from the ECU 103. The second drive IC 74 is one example of a “second control unit” of the present disclosure. The second drive IC 74 includes a logic device connected to the second switching element 73. The logic device includes, for example, a logic circuit, a processor, a complex programmable logic device (CPLD), a field-programmable gate array (FPGA), an application-specific integrated circuit (ASIC), or the like. The logic device performs arithmetic processing for causing the ignition device 1 to operate, to maintain electric spark generated in the spark plug 101 for a longer period of time.

The casing 107 is a container made of resin having insulation performance. The casing 107 forms an exterior shape of the ignition device 1 and has a substantially concave shape that is opened vertically upward. Thus, the opening 120 is formed at an upper end of the casing 107. The casing 107 accommodates respective components including the ignition coil 104, the first igniter 105, and the second igniter 106. More specifically, the casing 107 accommodates the first primary coil L11, the first secondary coil L12, the first penetrating core 61, the second primary coil L21, the second secondary coil L22, the second penetrating core 62, the one-end peripheral core 63, the other-end peripheral core 64, the first igniter 105, and the second igniter 106. Further, the casing 107 includes a main accommodation portion 91, a first connector portion 921, a second connector portion 922, fixing portions 931 and 932, and a lower accommodation portion 94.

The main accommodation portion 91 has a concave shape that is opened vertically upward. The above-described opening 120 is formed at an upper end of the main accommodation portion 91. Hereinafter, a space inside the main accommodation portion 91 will be referred to as an “inner space 910”. In the inner space 910, the ignition coil 104, the first igniter 105, and the second igniter 106 are accommodated. The ignition coil 104 is accommodated in the inner space 910 with the first axis direction of the first coil set 40 and the second axis direction of the second coil set 50 being set to a horizontal direction. Further, the first igniter 105 is placed on one side of the first coil set 40 with respect to the first axis direction. Meanwhile, the second igniter 106 is placed on one side of the second coil set 50 with respect to the second axis direction. Moreover, around the ignition coil 104, the first igniter 105, and the second igniter 106, conductors and the like connected to the respective components are appropriately placed.

In a process of manufacturing the ignition device 1, the ignition coil 104, the first igniter 105, the second igniter 106, and the conductors and the like connected to those components are placed in the inner space 910, and in this state, thermosetting mold resin for insulating and fixing those components is poured. That is, the casing 107 is filled with the thermosetting mold resin. For the mold resin, for example, epoxy resin is used. The mold resin is poured to the level of the vicinity of the opening 120 in the casing 107. Thus, after the mold resin is cured, the resin portion 108 filling gaps in the casing 107 is formed. Consequently, the respective components including the ignition coil 104, the first igniter 105, and the second igniter 106 are held at appropriate positions in the inner space 910.

Meanwhile, at the respective upper ends of the one-end peripheral core 63 and the other-end peripheral core 64 of the present embodiment, corner portions of silicon steel sheets (laminated steel) forming the one-end peripheral core 63 and the other-end peripheral core 64 are arranged. Hence, there is concern that the corner portions may be points of occurrence of cracks in the mold resin. In view of this, as shown in FIG. 5, a resin cover 66 is fitted in the upper surface of the one-end peripheral core 63 and the upper surface of the other-end peripheral core 64 while being in contact with the upper surfaces, so as to cover the upper surfaces. Thus, the corner portions of the silicon steel sheets (laminated steel) present at the upper ends of the one-end peripheral core 63 and the other-end peripheral core 64 are protected by the resin cover 66, and hence, occurrence of cracks in the mold resin can be suppressed.

In this regard, at the time of driving the ignition coil 104, a current repeatedly flows through the respective primary coils L11 and L21 of the coil sets 40 and 50 surrounded by the resin portion 108 in the casing 107, details of which will be given later. Hence, heat is repeatedly generated mainly from the respective primary coils L11 and L21. Then, if such heat remains in the casing 107, it possibly affects the surrounding components. For this reason, it is required to remove the generated heat and dissipate the heat to the outside of the casing 107. However, the epoxy resin forming the resin portion 108 surrounding the respective coil sets 40 and 50 has thermal conductivity as low as approximately 0.1 to 0.8 W/mK. Hence, it is difficult to dissipate heat generated from the respective primary coils L11 and L21 and the like to the outside of the casing 107 via the resin portion 108.

Meanwhile, an electrical steel sheet (35A300) forming the first penetrating core 61 penetrating the inside of the first primary coil L11 and the second penetrating core 62 penetrating the inside of the second primary coil L21 has thermal conductivity as high as approximately 20 W/mK, but the penetrating cores are placed at positions downward away from the opening 120 of the casing 107. Further, as described above, each of the first penetrating core 61 and the second penetrating core 62 is placed away also from the side surface of the casing 107.

Then, in the present disclosure, the respective upper ends of the one-end peripheral core 63 and the other-end peripheral core 64 that connect the first penetrating core 61 and the second penetrating core 62 are positioned above the first secondary coil L12 and the second secondary coil L22. Specifically, the respective upper ends of the one-end peripheral core 63 and the other-end peripheral core 64 are placed at upper positions near the resin surface 109 that is an upper surface of the resin portion 108. In other words, the respective upper ends of the one-end peripheral core 63 and the other-end peripheral core 64 are placed at upper positions near the opening 120 of the casing 107.

This enables transfer of heat generated from the primary coils L11 and L21 and the like of the respective coil sets 40 and 50, to the upper side, while suppressing the influence of thermal resistance of the mold resin forming the resin portion 108. Consequently, heat generated from the primary coils L11 and L21 and the like of the respective coil sets 40 and 50 can be dissipated to above the casing 107 via the one-end peripheral core 63 and the other-end peripheral core 64.

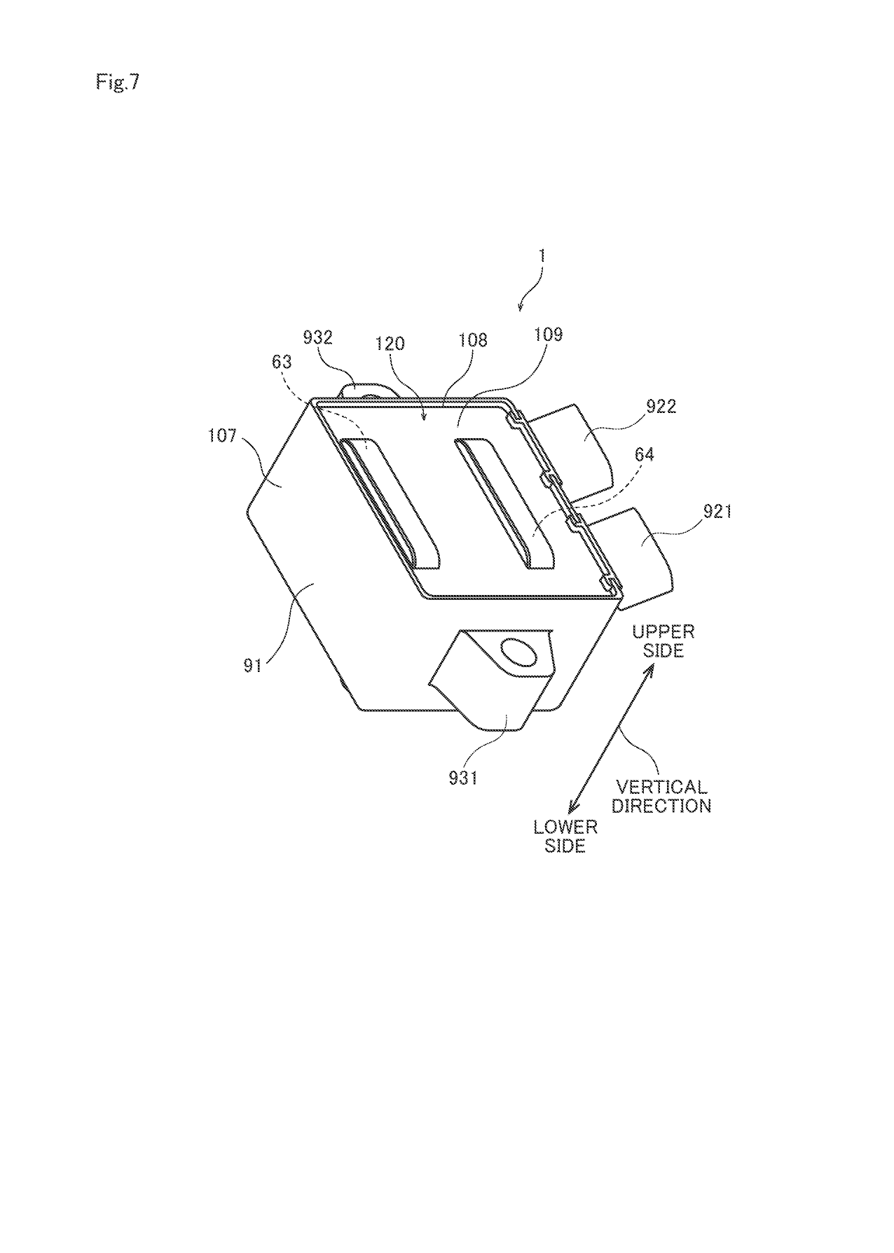

Note that, as shown in a first modification in FIG. 7, both or one of the respective upper ends of the one-end peripheral core 63 and the other-end peripheral core 64 may be exposed above the resin surface 109. Specifically, the upper end of the one-end peripheral core 63 and/or the upper end of the other-end peripheral core 64 may be exposed above the upper surface of the mold resin forming the resin portion 108. This allows heat generated from the primary coils L11 and L21 and the like of the respective coil sets 40 and 50 to be efficiently dissipated to above the casing 107 via the one-end peripheral core 63 and the other-end peripheral core 64.

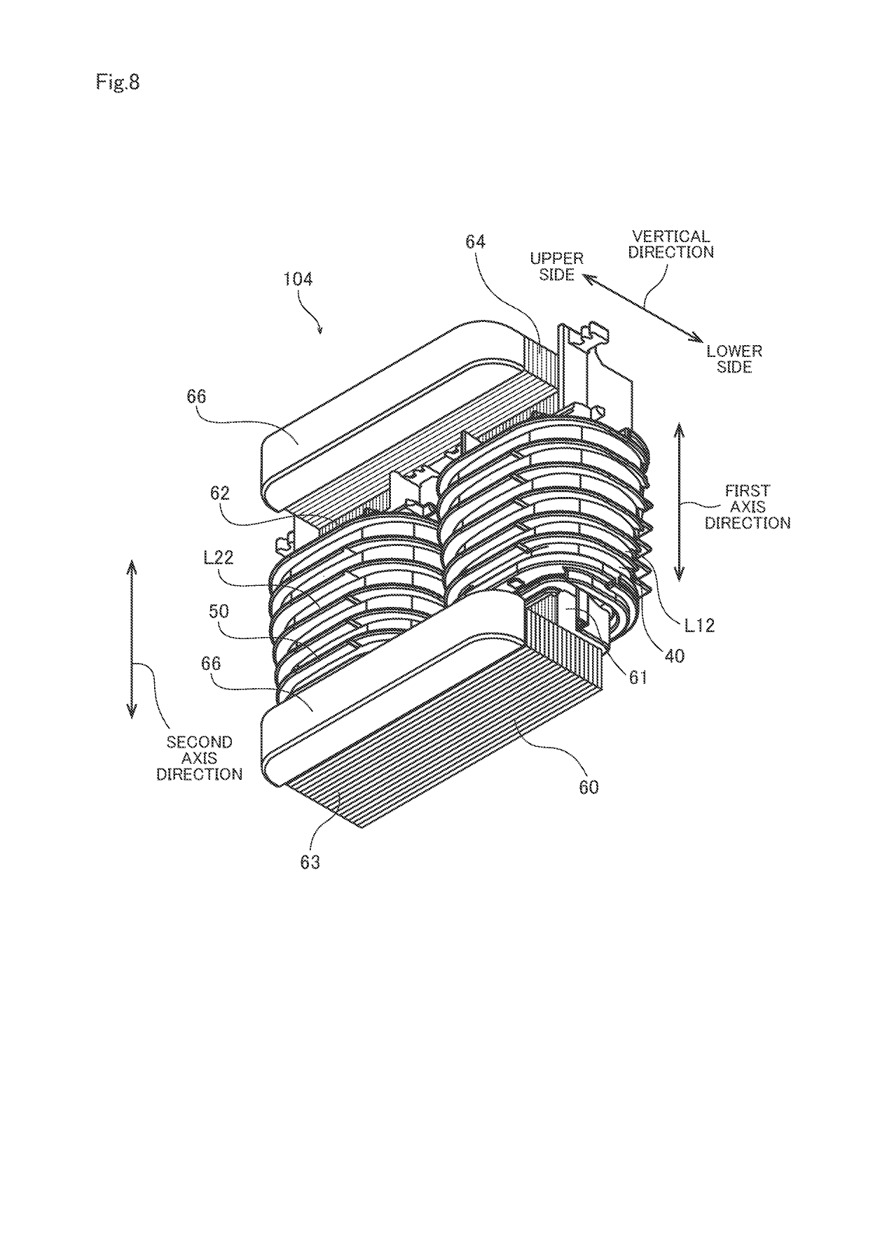

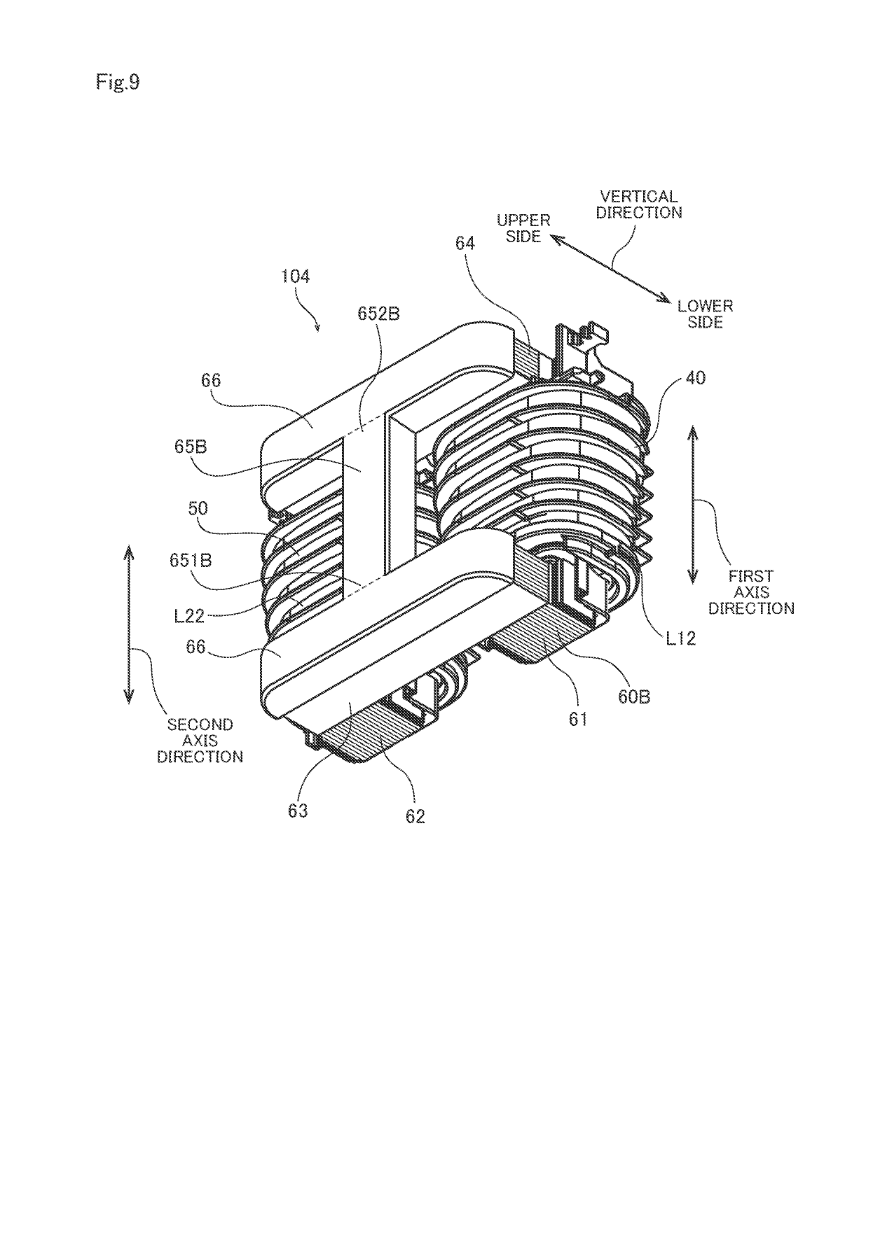

Alternatively, as shown in a second modification in FIG. 8, the one-end peripheral core 63 may be provided adjacently to an end surface of the first penetrating core 61 on one side with respect to the first axis direction and adjacently to an end surface of the second penetrating core 62 on one side with respect to the second axis direction. Further, the other-end peripheral core 64 may be provided adjacently to an end surface of the first penetrating core 61 on the other side with respect to the first axis direction and adjacently to an end surface of the second penetrating core 62 on the other side with respect to the second axis direction. Also in this case, each of the one-end peripheral core 63 and the other-end peripheral core 64 can connect the first penetrating core 61 and the second penetrating core 62.

Then, also in the second modification, in the same manner as in the present embodiment, the respective upper ends of the one-end peripheral core 63 and the other-end peripheral core 64 are positioned above the first secondary coil L12 and the second secondary coil L22. In other words, the respective upper ends of the one-end peripheral core 63 and the other-end peripheral core 64 are placed at upper positions near the resin surface 109 and the opening 120 of the casing 107. This allows heat generated from the primary coils L11 and L21 and the like of the respective coil sets 40 and 50 to be transferred to the upper side via the one-end peripheral core 63 and the other-end peripheral core 64 and be dissipated to above the casing 107, while suppressing the influence of thermal resistance of the mold resin forming the resin portion 108.

As shown in FIGS. 2 to 4, the first connector portion 921 and the second connector portion 922 are provided so as to be horizontally arranged side by side on a side portion of the main accommodation portion 91 of the casing 107. The first connector portion 921 is provided on one side of the first igniter 105 with respect to the first axis direction. The conductor connected to the first igniter 105 and the power supply line 150 extending from the first primary winding 811 are drawn to the outside of the casing 107 via the first connector portion 921 and are connected to the ECU 103, the power supply device 102, and the like. The second connector portion 922 is provided on one side of the second igniter 106 with respect to the second axis direction. The conductor connected to the second igniter 106 and the power supply line 150 extending from the second primary winding 821 are drawn to the outside of the casing 107 via the second connector portion 922 and are connected to the ECU 103, the power supply device 102, and the like.

Further, on the side portion of the main accommodation portion 91 of the casing 107, the fixing portions 931 and 932 are provided at positions different from the positions where the first connector portion 921 and the second connector portion 922 are provided. The fixing portions 931 and 932 are formed at positions where the fixing portions face each other. Each of the fixing portions 931 and 932 is a substantially triangular-prism-shaped part protruding from the main accommodation portion 91, used for mounting and fixing the ignition device 1 onto an engine block.

Moreover, the lower accommodation portion 94 is a component vertically extending in a tubular shape. The lower accommodation portion 94 has an upper end fixed to the vicinity of the center of a bottom of the main accommodation portion 91. Meanwhile, in a space inside the lower accommodation portion 94, the high-voltage terminal HG is fixed. That is, the high-voltage terminal HG is held below the ignition coil 104 in the casing 107. Further, a hole 915 passing through the bottom of the main accommodation portion 91 is provided in the vicinity of the center of the bottom of the main accommodation portion 91. The space inside the lower accommodation portion 94 communicates with the inner space 910 of the main accommodation portion 91 via the hole 915. The secondary-side ground wire Cg20 is inserted into the lower accommodation portion 94 and is connected to the high-voltage terminal HG via the hole 915.

### <1-2. Operations of Ignition Device>

Next, operations of the ignition device 1 will be described.

In causing the ignition device 1 to operate, first, a signal level of the first EST signal S1 transmitted from the ECU 103 to the first drive IC 72 is changed from L to H at a time t0. Then, in response to the first EST signal S1, the first drive IC 72 changes a state of the first switching element 71 from an open state to a closed state. Thus, a low direct-current voltage from the power supply device 102 is applied to the one end Ep11 of the first primary coil L11. Then, the first primary current flows through the first primary winding 811 forming the first primary coil L11, and magnetomotive force is generated in the first primary coil L11. Further, an energization magnetic flux φa1 directed from the other end 612 to the one end 611 is generated in the first penetrating core 61, and a magnetic field corresponding to the energization magnetic flux φa1 acts on the iron core 60.

Subsequently, at a time t1 after the time t0, the signal level of the first EST signal S1 transmitted from the ECU 103 to the first drive IC 72 is changed from H to L, and at the same time, a signal level of the second EST signal S2 transmitted from the ECU 103 to the second drive IC 74 is changed from L to H. Then, the first drive IC 72 changes a state of the first switching element 71 from a closed state to an open state, to interrupt the primary current (the first primary current) flowing from the power supply device 102 to the first primary coil L11. As a result, a de-energization magnetic flux φs1 in a direction opposite to the direction of the above-described energization magnetic flux φa1 is generated by the mutual induction effect, and at the same time, large induced electromotive force is caused, in the first secondary coil L12 electromagnetically coupled to the first primary coil L11 via the iron core 60. At that time, a value of a voltage applied to the one end Eg12 of the first secondary coil L12 ranges from minus several thousands of volts to several tens of thousands of volts with respect to the ground point 151. Consequently, electric spark is generated and a fuel is ignited in the spark plug 101 connected to the one end Eg12 of the first secondary coil L12, so that an induced current (first secondary current) flows through the first secondary coil L12.

Moreover, at the time t1, the second drive IC 74 changes a state of the second switching element 73 from an open state to a closed state. As a result, a low direct-current voltage from the power supply device 102 is applied to the one end Ep21 of the second primary coil L21. Then, the second primary current flows through the second primary winding 821 forming the second primary coil L21, and magnetomotive force is generated in the second primary coil L21. Further, an energization magnetic flux φb1 directed from the other end 622 to the one end 621 is generated in the second penetrating core 62, and a magnetic field corresponding to the energization magnetic flux φb1 acts on the iron core 60. Note that the direction of the energization magnetic flux φb1 is the same as the direction of the above-described de-energization magnetic flux φs1. Hence, a magnetic flux generated in the closed magnetic circuit of the iron core 60 is amplified. Consequently, a current and ignition energy supplied to the spark plug 101 can be increased.

Further, at a time t2 after the time t1, the signal level of the second EST signal S2 transmitted from the ECU 103 to the second drive IC 74 is changed from H to L, and at the same time, the signal level of the first EST signal S1 transmitted from the ECU 103 to the first drive IC 72 is changed from L to H. Then, the second drive IC 74 changes a state of the second switching element 73 from a closed state to an open state, to interrupt the primary current (the second primary current) flowing from the power supply device 102 to the second primary coil L21. As a result, a de-energization magnetic flux φs2 in a direction opposite to the direction of the above-described energization magnetic flux φb1 is generated by the mutual induction effect, and at the same time, large induced electromotive force is caused, in the second secondary coil L22 electromagnetically coupled to the second primary coil L21 via the iron core 60. At that time, a value of a voltage applied to the one end Eg22 of the second secondary coil L22 ranges from minus several thousands of volts to several tens of thousands of volts with respect to the ground point 151. Consequently, electric spark and flames generated around the spark plug 101 connected to the one end Eg22 of the second secondary coil L22 can be maintained, so that an induced current (second secondary current) flows through the second secondary coil L22.

Moreover, at the time t2, the first drive IC 72 changes a state of the first switching element 71 from an open state to a close state. As a result, a low direct-current voltage from the power supply device 102 is applied to the one end Ep11 of the first primary coil L11. Then, the first primary current flows through the first primary winding 811 forming the first primary coil L11, and magnetomotive force is generated in the first primary coil L11. Further, an energization magnetic flux φa2 directed from the other end 612 to the one end 611 is generated in the first penetrating core 61, and a magnetic field corresponding to the energization magnetic flux φa2 acts on the iron core 60. Note that the direction of the energization magnetic flux φa2 is the same as the direction of the above-described de-energization magnetic flux φs2. Hence, a magnetic flux generated in the closed magnetic circuit of the iron core 60 is amplified. Consequently, a current and ignition energy supplied to the spark plug 101 can be further increased.

As described above, the first drive IC 72 alternately repeats energization and de-energization of the first primary coil L11 a plurality of times. Meanwhile, the second drive IC 74 energizes the second primary coil L21 when the first drive IC 72 de-energizes the first primary coil L11, and after that, the second drive IC 74 de-energizes the second primary coil L21 when the first drive IC 72 energizes the first primary coil L11. By this control, flames generated around the spark plug 101 can be maintained for a much longer period of time.

<2. Second Preferred Embodiment>

Next, a second preferred embodiment of the present disclosure will be described. Note that, in the following description, differences from the first preferred embodiment will be mainly described, and duplicated description of parts similar to those in the first preferred embodiment will be omitted. Meanwhile, components having structures similar to those in the first preferred embodiment will be denoted with the same reference signs as those in the first preferred embodiment in the following description.

FIG. 9 is a perspective view of the ignition coil 104 according to the present embodiment. As shown in FIG. 9, the ignition coil 104 includes the first coil set 40, the second coil set 50, and an iron core 60B.

The iron core 60B of the present embodiment has a structure in which the first penetrating core 61, the second penetrating core 62, the one-end peripheral core 63, the other-end peripheral core 64, and a central core 65B are combined. Each of the first penetrating core 61, the second penetrating core 62, the one-end peripheral core 63, the other-end peripheral core 64, and the central core 65B is formed of, for example, laminated steel in which silicon steel sheets are stacked. Alternatively, another kind of steel sheet different from a silicon steel sheet may be used for each of the first penetrating core 61, the second penetrating core 62, the one-end peripheral core 63, the other-end peripheral core 64, and the central core 65B. Further alternatively, a dust core formed of a sintered material may be used for each of the first penetrating core 61, the second penetrating core 62, the one-end peripheral core 63, the other-end peripheral core 64, and the central core 65B.

In the same manner as in the first preferred embodiment, the one-end peripheral core 63 is placed above an end of the first penetrating core 61 on one side with respect to the first axis direction and above an end of the second penetrating core 62 on one side with respect to the second axis direction. Meanwhile, the other-end peripheral core 64 is placed above an end of the first penetrating core 61 on the other side with respect to the first axis direction and above an end of the second penetrating core 62 on the other side with respect to the second axis direction. Thus, each of the one-end peripheral core 63 and the other-end peripheral core 64 connects the first penetrating core 61 and the second penetrating core 62.

The central core 65B extends substantially horizontally and in a column shape substantially in parallel with the first axis direction and the second axis direction. The central core 65B is positioned between the first penetrating core 61 and the second penetrating core 62 when the ignition coil 104 is seen from above. The central core 65B has one end 651B connected to the one-end peripheral core 63. Further, the central core 65B has the other end 652B connected to the other-end peripheral core 64. That is, the central core 65B is placed between the first penetrating core 61 and the second penetrating core 62 and connects the one-end peripheral core 63 and the other-end peripheral core 64.

Thus, there is formed one ring-shaped closed magnetic circuit in which the first penetrating core 61, a part of the one-end peripheral core 63, the central core 65B, and a part of the other-end peripheral core 64 are connected in the stated order. Further, there is formed one ring-shaped closed magnetic circuit in which the second penetrating core 62, a part of the one-end peripheral core 63, the central core 65B, and a part of the other-end peripheral core 64 are connected in the stated order. Note that, in the present embodiment, when a direct-current voltage from the power supply device 102 is applied to the first primary coil L11, there is generated an energization magnetic flux that travels through the first penetrating core 61, a part of the one-end peripheral core 63, the central core 65B, and a part of the other-end peripheral core 64 in the stated order. Meanwhile, in the present embodiment, when a direct-current voltage from the power supply device 102 is applied to the second primary coil L21, there is generated an energization magnetic flux that travels through the second penetrating core 62, a part of the other-end peripheral core 64, the central core 65B, and a part of the one-end peripheral core 63 in the stated order.

Further, in the present embodiment, the respective upper ends of the one-end peripheral core 63, the other-end peripheral core 64, and the central core 65B are positioned above the first secondary coil L12 and the second secondary coil L22. Specifically, the respective upper ends of the one-end peripheral core 63, the other-end peripheral core 64, and the central core 65B are placed at upper positions near the resin surface 109 and the opening 120 of the casing 107. This allows heat generated from the respective primary coils L11 and L21 and the like of the coil sets 40 and 50 to be transferred to the upper side and be dissipated to above the casing 107 via the upper end of the one-end peripheral core 63, the upper end of the other-end peripheral core 64, and the central core 65B, while suppressing the influence of thermal resistance of the mold resin forming the resin portion 108.

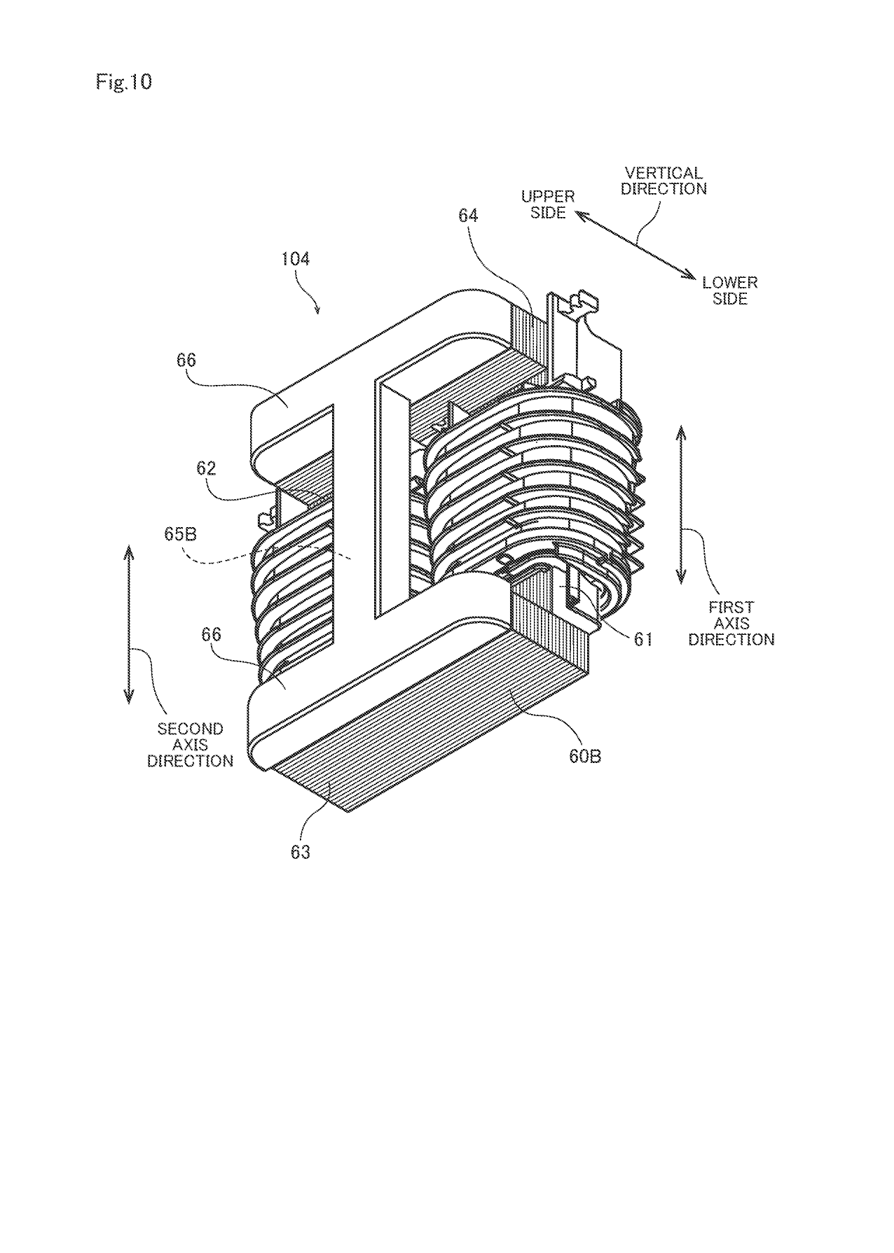

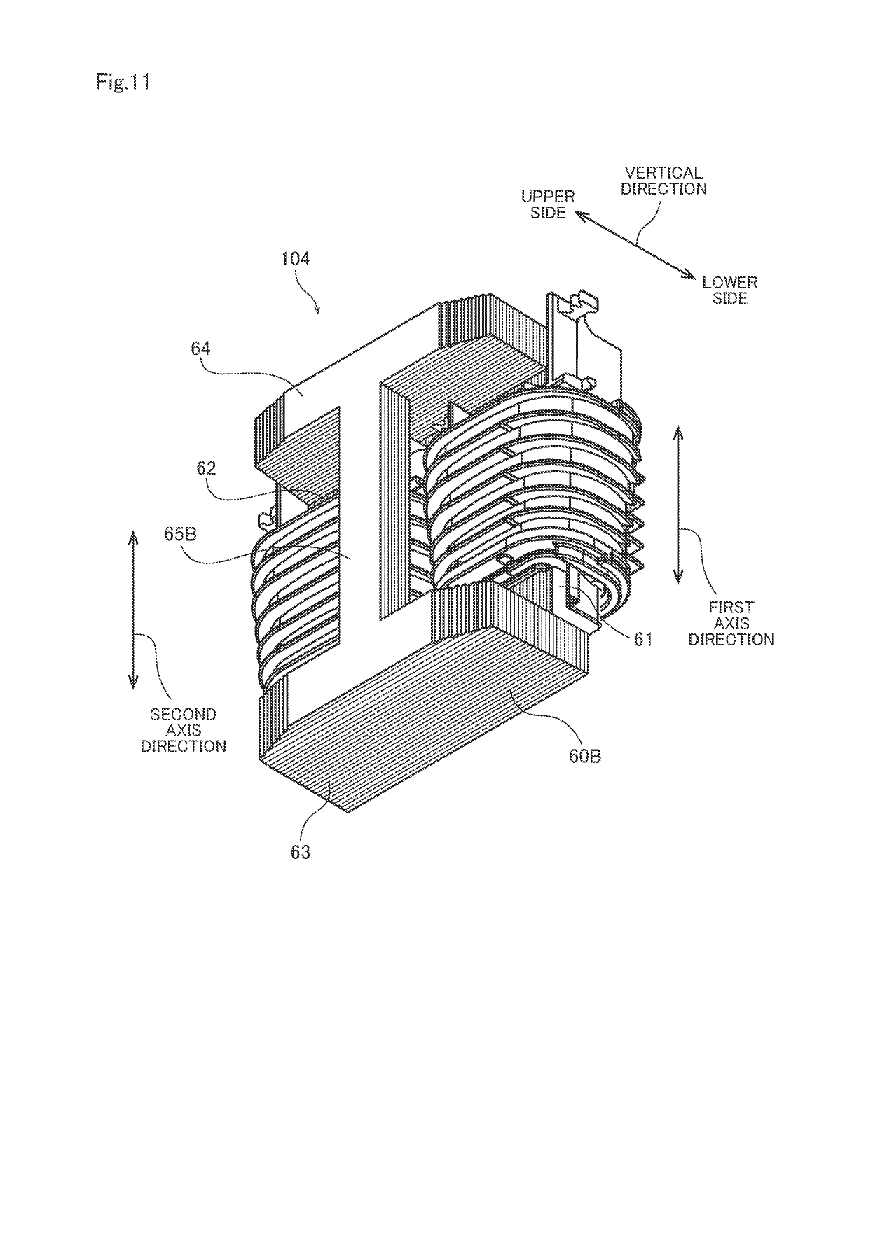

FIG. 10 is a perspective view of the ignition coil 104 according to a third modification. FIG. 11 is a perspective view of the ignition coil 104 in FIG. 10, in which the resin cover 66 is removed and the one-end peripheral core 63, the other-end peripheral core 64, and the central core 65B are uncovered. As shown in the third modification in FIGS. 10 and 11, the one-end peripheral core 63 may be provided adjacently to an end surface of the first penetrating core 61 on one side with respect to the first axis direction and adjacently to an end surface of the second penetrating core 62 on one side with respect to the second axis direction. Meanwhile, the other-end peripheral core 64 may be provided adjacently to an end surface of the first penetrating core 61 on the other side with respect to the first axis direction and adjacently to an end surface of the second penetrating core 62 on the other side with respect to the second axis direction. Also in this case, each of the one-end peripheral core 63 and the other-end peripheral core 64 can connect the first penetrating core 61 and the second penetrating core 62.

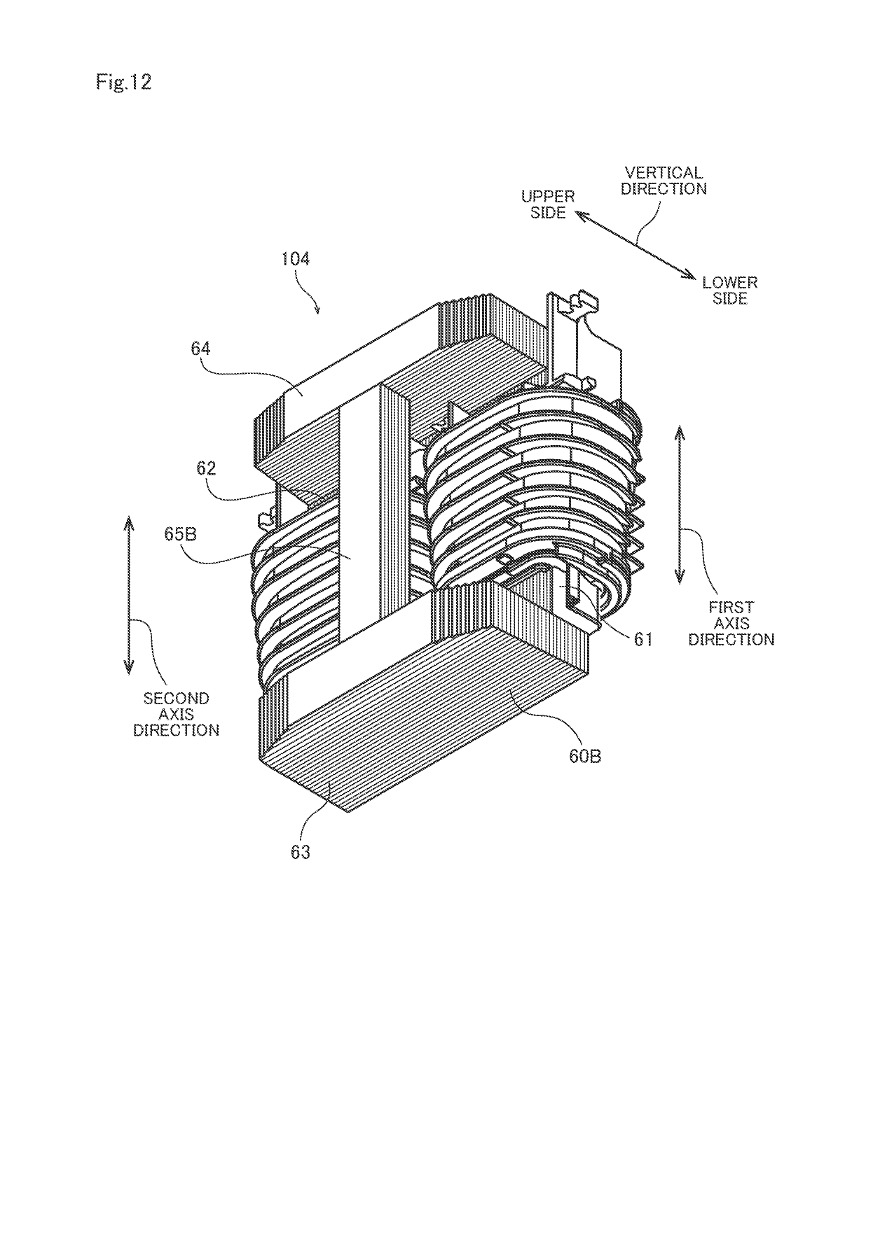

Note that, in the present modification, the central core 65B, a part of the one-end peripheral core 63, and a part of the other-end peripheral core 64 are formed of one same component. This enables reduction of the number of components in the entire ignition coil 104 including the iron core 60B. Alternatively, as shown in a fourth modification in FIG. 12, the central core 65B, the one-end peripheral core 63, and the other-end peripheral core 64 may be formed of different components, respectively. Further alternatively, the central core 65B and either a part of the one-end peripheral core 63 or a part of the other-end peripheral core 64 may be formed of different components, respectively. Thus, during manufacture of steel sheets for forming the iron core 60B having a complicated shape, materials can be punched at a high yield rate for manufacture. Consequently, the iron core 60B can be formed more easily.

That is, as shown in the third modification in FIG. 11, the central core 65B and at least a part of the one-end peripheral core 63 and/or at least a part of the other-end peripheral core 64 may be formed of one same component. This enables reduction of the number of components in the entire ignition coil 104 including the iron core 60B. Alternatively, as shown in the fourth modification in FIG. 12, the central core 65B and at least a part of the one-end peripheral core 63 and/or at least a part of the other-end peripheral core 64 may be formed of different components, respectively. Thus, during manufacture of steel sheets for forming the central core 65B and the one-end peripheral core 63 and/or the other-end peripheral core 64, materials can be punched at a high yield rate for manufacture. Consequently, the iron core 60B can be formed more easily.

In causing the ignition device 1 to operate, the first drive IC 72 alternately repeats energization and de-energization of the first primary coil L11 a plurality of times. When the first primary coil L11 is de-energized, there is generated a de-energization magnetic flux that travels through the first penetrating core 61, a part of the other-end peripheral core 64, the central core 65B, and a part of the one-end peripheral core 63 in the stated order. At that time, a value of a voltage applied to the one end Eg12 of the first secondary coil L12 ranges from minus several thousands of volts to several tens of thousands of volts with respect to the ground point 151. Consequently, electric spark is generated and a fuel is ignited in the spark plug 101 connected to the one end Eg12 of the first secondary coil L12, and thus an induced current (first secondary current) flows through the first secondary coil L12.

Further, the second drive IC 74 alternately repeats energization and de-energization of the second primary coil L21 a plurality of times. When the second primary coil L21 is de-energized, there is generated a de-energization magnetic flux that travels through the second penetrating core 62, a part of the other-end peripheral core 64, the central core 65B, and a part of the one-end peripheral core 63 in the stated order. At that time, a value of a voltage applied to the one end Eg22 of the second secondary coil L22 ranges from minus several thousands of volts to several tens of thousands of volts with respect to the ground point 151. Consequently, electric spark and flames generated around the spark plug 101 connected to the one end Eg22 of the second secondary coil L22 can be maintained, and thus an induced current (second secondary current) flows through the second secondary coil L22.

<3. Modifications>

The illustrative preferred embodiments of the present disclosure have been described above, but the present invention is not limited to the above-described preferred embodiments.

The ignition coil and the ignition device according to the present disclosure can be applied to any device that is mounted in various apparatuses such as a power generator or industrial machines, in addition to a vehicle such as an automobile, and is used for generating electric spark in a spark plug of an internal combustion engine, to ignite a fuel.

The details of the shapes and configurations of the ignition coil and the ignition device described above may be appropriately changed within a scope not departing from the gist of the present disclosure. Further, the respective elements described in the above-described preferred embodiments and modifications may be appropriately combined unless contradiction arises.

What is claimed is:

1. An ignition coil for use in an internal combustion engine, comprising:
a first primary coil including a first primary winding, in which a direct-current voltage is applied to one end and the other end is connected to a ground point;
a first secondary coil including a first secondary winding; a first penetrating core that penetrates an inside of the first primary coil and an inside of the first secondary coil and is configured to electromagnetically couple the first primary coil and the first secondary coil; a second primary coil including a second primary winding, in which the direct-current voltage is applied to one end and the other end is connected to the ground point; a second secondary coil including a second secondary winding; a second penetrating core that penetrates an inside of the second primary coil and an inside of the second secondary coil and is configured to electromagnetically couple the second primary coil and the second secondary coil; a one-end peripheral core connecting one end of the first penetrating core and one end of the second penetrating core; an other-end peripheral core connecting the other end of the first penetrating core and the other end of the second penetrating core; and a casing that is opened upward to have a concave shape in which an opening is formed at an upper end, and accommodates the first primary coil, the first secondary coil, the first penetrating core, the second primary coil, the second secondary coil, the second penetrating core, the one-end peripheral core, and the other-end peripheral core, wherein the casing is filled with thermosetting mold resin, and respective upper ends of the one-end peripheral core and the other-end peripheral core are positioned above the first secondary coil and the second secondary coil.

2. The ignition coil according to claim 1, wherein the upper end of the one-end peripheral core and/or the upper end of the other-end peripheral core are exposed above an upper surface of the mold resin.

3. The ignition coil according to claim 1, further comprising
a central core that is placed between the first penetrating core and the second penetrating core and connects the one-end peripheral core and the other-end peripheral core.

4. The ignition coil according to claim 3, wherein the central core and at least a part of the one-end peripheral core and/or at least a part of the other-end peripheral core are formed of one same component.

5. The ignition coil according to claim 3, wherein the central core and at least a part of the one-end peripheral core and/or at least a part of the other-end peripheral core are formed of different components, respectively.

6. An ignition device comprising:
the ignition coil according to claim 1;
a power supply device configured to apply the direct-current voltage to each of the one end of the first primary coil and the one end of the second primary coil;
a first switching element that is interposed between the other end of the first primary coil and the ground point and is configured to perform switching between passage and interruption of a first primary current flowing from the power supply device to the first primary coil; a second switching element that is interposed between the other end of the second primary coil and the ground point and is configured to perform switching between passage and interruption of a second primary current flowing from the power supply device to the second primary coil; a first control unit configured to control the switching of the first switching element; a second control unit configured to control the switching of the second switching element; and a spark plug configured to ignite a fuel by occurrence of discharge at a gap in accordance with a high voltage induced at one end of the first secondary coil and/or a high voltage induced at one end of the second secondary coil.

7. The ignition device according to claim 6, further comprising a high-voltage terminal that is held below the ignition coil in the casing and is interposed in a conductor connecting the one end of the first secondary coil and the one end of the second secondary coil to the spark plug.
